(19) United States
(12) Patent Application Publication
(10) Pub. No.: US 2012/0130944 A1
(43) Pub. Date: May 24, 2012

(54) MAP INFORMATION PROCESSING DEVICE

(76) Inventors: Hisanobu Masuda, Tokyo (JP); Makoto Mikuriya, Tokyo (JP); Tomoya Ikeuchi, Tokyo (JP); Kosei Uchino, Tokyo (JP)

(21) Appl. No.: 13/388,250

(22) PCT Filed: Oct. 21, 2009
(86) PCT No.: PCT/JP2009/005520

§ 371 Date: Jan. 31, 2012

(51) Int. Cl. G06F 17/30

(52) U.S. Cl. 707/609; 707/E17.01

(57) ABSTRACT

Disclosed is a map information processing device including an update information acquiring unit for acquiring update information for updating map information including regional map files and mesh management information, and a processor for updating each regional map file of the map information by using the update information, in which each regional map file stores mesh information, the mesh management information includes mesh management records, each mesh management record includes file identifying information for identifying a regional map file including a corresponding mesh, version information about the version of the regional map file, and mesh storage location information showing the storage location of the mesh information in the regional map file, and the file identifying information of a mesh management record corresponding to a mesh stored in a plurality of regional map files determines the latest version of a regional map file.

### FIELD OF THE INVENTION

The present invention relates to a map information processing device which processes map information. More particularly, it relates to a technique for updating map information.

### BACKGROUND OF THE INVENTION

For example, patent reference 1 discloses, as a map information processing device, a vehicle-mounted navigation device which can make an appropriate search for a route when a place of departure or/and a destination exist close to the boundary between administrative districts even in a case in which the versions of the map data about the two adjacent administrative districts differ from each other due to an update of map data which are formed in units of an administrative district.

In this vehicle-mounted navigation device, a lower layer map which is formed of common meshes in a portion corresponding to a boundary area between two adjacent administrative districts, and exclusive meshes in a portion corresponding to an area other than boundary areas in each administrative district is stored in an HDD (Hard Disk Drive), and, when determining that the existing lower layer map of an administrative district (B prefecture) adjacent to another administrative district (A prefecture), which is an update object, does not have the same version as a lower layer map for update of A prefecture when updating the existing lower layer map of A prefecture, a control unit stores the lower layer map for update of A prefecture in the HDD in such a way as to overwrite the existing lower layer map of B prefecture with the lower layer map for update of A prefecture in the common meshes of the data about those lower layer maps.

Furthermore, patent reference 2 discloses an updating system for updating map data appropriately. In this updating system, map information is divided into arbitrary areas, and the map information is updated in units of an arbitrary area. As arbitrary areas, administrative districts, such as prefectures, meshes, or blocks are used.

### RELATED ART DOCUMENT

### Patent Reference

Patent reference 1: Japanese Unexamined Patent Application Publication No. 2009-080079
Patent reference 2: Japanese Unexamined Patent Application Publication No. 2005-338687

In the vehicle-mounted navigation device disclosed in above-mentioned patent reference 1, because map data are stored while being divided into exclusive meshes each of which consists of only one administrative district, and common meshes each of which consists of a plurality of administrative districts, the number of files which should be managed increases and hence the management becomes complicated. Furthermore, because the structure of the exclusive meshes and the common meshes varies when administrative districts are integrated or an administrative district is divided, there is a problem that the range of update map information to be provided for users cannot be changed easily.

Furthermore, in the updating system disclosed in patent reference 2, in a case in which administrative districts, such as prefectures, are defined as arbitrary areas, there is a merit that the usage fee of map information about any area outside the range of update map information to be provided for users is unnecessary because any area other than specific administrative districts is not included in the arbitrary areas, while when there is a digitization error in the map information, and the range of update map information to be provided for users differs due to integration of administrative districts or division of an administrative district, there is a possibility that there exists an area whose map data has a loss after the update.

Another problem with the updating system disclosed in patent reference 2 is that when the map information is divided in such a way that administrative districts, such as prefectures, are included in the arbitrary areas in a case in which meshes or blocks are defined as the arbitrary areas, meshes shared among a plurality of administrative districts have no other choice but to be included in only one of the administrative districts.

The present invention is made in order to solve the above-mentioned problems, and it is therefore an object of the present invention to provide a map information processing device which can easily perform management and an update of map information.

### SUMMARY OF THE INVENTION

In accordance with the present invention, there is provided a map information processing device including: a map information storage unit for storing map information about a map in which a creation region is managed while being divided into meshes, the map information including both regional map files each of which is provided for an arbitrary region, and mesh management information for managing the meshes; an update information acquiring unit for acquiring update information for updating the map information stored in the map information storage unit; and a processor for updating each of the regional map files of the map information stored in the map information storage unit by using the update information acquired by the update information acquiring unit, in which each of the regional map files stores mesh information which is map information about meshes including an arbitrary region corresponding to the regional map file, the mesh management information includes mesh management records disposed in such a way as to respectively correspond to the meshes, each of the mesh management records includes file identifying information for identifying a regional map file including a corresponding mesh, version information about a version of the regional map file, and mesh storage location information showing a storage location of mesh information in the regional map file, and the file identifying information of a mesh management record corresponding to a mesh stored in a plurality of regional map files determines the latest version of a regional map file.

The map information processing device in accordance with the present invention can facilitate the management in the case of managing an aggregate of meshes including an arbitrary region by using a single file, and can update the map information in units of a regional map file including an arbitrary region. Furthermore, because the map information processing device can simply replace each regional map file with a new regional map file and can simply rewrite management information used for managing regional map files, the map information processing device enables the user to easily perform an updating operation.

### BRIEF DESCRIPTION OF THE FIGURES

FIG. 1 is a block diagram showing the structure of a map information processing device in accordance with Embodiment 1 of the present invention;

FIG. 2 is a view for explaining meshes in each hierarchical layer of map information for use in the map information processing device in accordance with Embodiment 1 of the present invention;

FIG. 3 is a view showing an example of arbitrary regions which exist in a creation range of the map information for use in the map information processing device in accordance with Embodiment 1 of the present invention;

FIG. 4 is a view showing an example of meshes in which the creation range of the map information divided into the meshes shown in FIG. 2 is included in regional map files respectively corresponding to the arbitrary regions A to F;

FIG. 5 is a view showing an example of the regional map files stored in a map information storage unit of the map information processing device in accordance with Embodiment 1 of the present invention;

FIG. 6 is a view showing an example of the regional map file #0 (A) shown in FIG. 5;

FIG. 7 is a view showing an example of mesh information included in the regional map file shown in FIG. 6;

FIG. 8 is a view showing an example of mesh management information stored in the map information storage unit of the map information processing device in accordance with Embodiment 1 of the present invention;

FIG. 9 is a view for explaining an example of a setting of the version of each regional map file in the map information processing device in accordance with Embodiment 1 of the present invention;

FIG. 10 is a view for explaining another example of the setting of the version of each regional map file in the map information processing device in accordance with Embodiment 1 of the present invention;

FIG. 11 is a view showing an example of update information for use in the map information processing device in accordance with Embodiment 1 of the present invention;

FIG. 12 is a view showing an example of mesh management information for update included in the update information for use in the map information processing device in accordance with Embodiment 1 of the present invention;

FIG. 13 is a view showing an example of a mesh management record for update in the mesh management information for update of the update information for use in the map information processing device in accordance with Embodiment 1 of the present invention;

FIG. 14 is a view showing an example of deletion information included in the update information for use in the map information processing device in accordance with Embodiment 1 of the present invention;

FIG. 15 is a view showing an example of update regional map file range information included in the update information for use in the map information processing device in accordance with Embodiment 1 of the present invention;

FIG. 16 is a flow chart showing main processing carried out by the map information processing device in accordance with Embodiment 1 of the present invention;

FIG. 17 is a flow chart showing the details of a map updating process performed in step ST11 of FIG. 16;

FIG. 18 is a flow chart showing the details of map information acquiring processing performed in step ST14 of FIG. 16;

FIG. 19 is a flow chart showing the details of a process of urging acquisition of map information which is performed in step ST17 of FIG. 16;

FIG. 20 is a view showing an example of a screen displayed through the process of urging acquisition of map information which is carried out by the map information processing device in accordance with Embodiment 1 of the present invention;

FIG. 21 is a view showing an example of update information for use in a map information processing device in accordance with Embodiment 2 of the present invention; and

FIG. 22 is a flow chart showing the details of a map updating process carried out by the map information processing device in accordance with Embodiment 2 of the present invention.

### EMBODIMENTS OF THE INVENTION

Hereafter, in order to explain this invention in greater detail, the preferred embodiments of the present invention will be described with reference to the accompanying drawings. Embodiment 1.

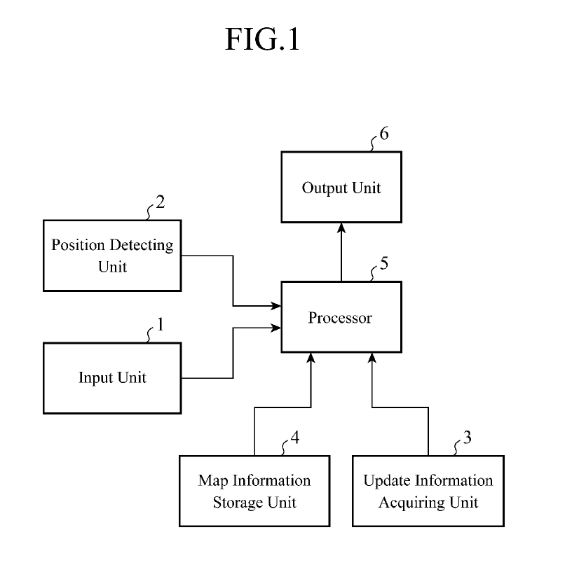

FIG. 1 is a block diagram showing the structure of a map information processing device in accordance with Embodiment 1 of the present invention. This map information processing device is provided with an input unit 1, a position detecting unit 2, an update information acquiring unit 3, a map information storage unit 4, a processor 5, and an output unit 6.

The input unit 1 creates a command signal according to a user's operation or command, and sends the command signal to the processor 5. For example, this input unit 1 is comprised of at least one of a voice recognition device for recognizing the user's voice to create a command signal, operation buttons for creating a command signal according to the user's manual operation, and another input unit.

The position detecting unit 2 detects the current position of a vehicle in which the map information processing device is mounted by using, for example, a GPS (Global Positioning System) receiver, a speed sensor, and an angular velocity sensor (which are not shown in the figure). The current position detected by this position detecting unit 2 is sent to the processor 5 as position information.

The update information acquiring unit 3 consists of, for example, a memory card reader. The update information acquiring unit reads update information stored in a memory card, and sends the update information to the processor 5. The details of the update information read by this update information acquiring unit 3 will be mentioned later. As the update information acquiring unit 3, a communication unit for acquiring the update information from a server which manages map information for update via communications can be alternatively used.

The map information storage unit 4 consists of, for example, a hard disk drive which uses a hard disk as a storage medium. The map information storage unit stores map information and information for managing the map information in advance. Information stored in this map information storage unit 4 is read by the processor 5.

The processor 5 carries out various map information processes using the command signal sent from the input unit 1, the position information sent from the position detecting unit 2, and the map information read from the map information storage unit 4. The map information processes include a map matching process of estimating the current position of the vehicle according to both the position information acquired from the position detecting unit 2 and the map information read from the map information storage unit 4, a route determining process of determining a route from a place of departure to a destination (route search process), a route display process of displaying candidates for an optimal route acquired through the route determination, as well as a road map, on the screen of a display unit which is included in the output unit 6, a route guiding process of providing guidance on the optimal route from the place of departure to the destination according to the optimal route, a display process of displaying a map of an area surrounding the current position, and various search processes, such as a facility search, an address search, and a phone number search. Furthermore, the processor 5 updates the map information and the information for managing the map information which are stored in the map information storage unit 4 by using the update information sent thereto from the update information acquiring unit 3.

The output unit 6 presents various pieces of information according to display information sent thereto from the processor 5 to the user. Although not illustrated, this output unit 6 can consist of the display unit for displaying a map, the current position, a route, guidance information, search results, etc., and a voice generator for providing an instruction or guidance for the user by voice.

Next, the map information for use in the map information processing device in accordance with Embodiment 1 will be explained. A creation range of the map information is defined by a rectangular region enclosed by latitude lines and longitude lines. Furthermore, the map information is hierarchically organized according to the degree of details of the information, and the creation range of the map information is managed for each hierarchical layer with the creation range being divided into meshes each of which is a rectangular region enclosed by adjacent latitude lines which are spaced at a predetermined spacing and adjacent longitude lines which are spaced at a predetermined spacing.

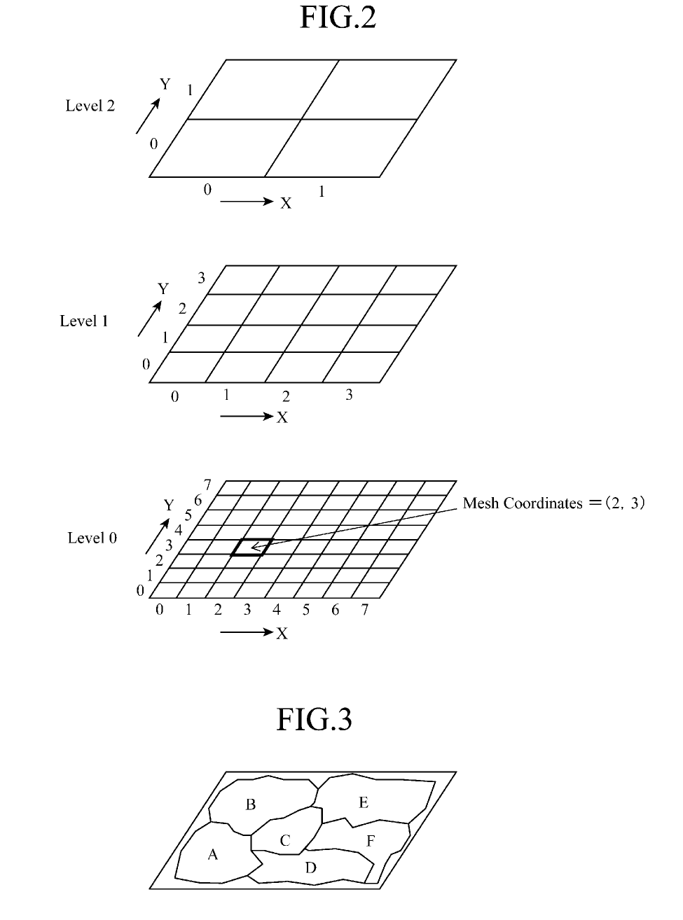

FIG. 2 shows an example of meshes in each hierarchical layer. In this example, it is assumed that the map information is hierarchically organized into three hierarchical layers including level 0, level 1, and level 2, and the degrees of detail of the three layers increase in order of level 2→level 1→level 0. The creation range is divided into 8×8 meshes in the layer of level 0, the creation range is divided into 4×4 meshes in the layer of level 1, and the creation range is divided into 2×2 meshes in the layer of level 2.

Therefore, when the longitude of the left end of the rectangular region which is the creation range is expressed as Wxmin, the longitude of the right end of the rectangular region is expressed as Wxmax, the latitude of the lower end of the rectangular region is expressed as Wymin, the latitude of the upper end of the rectangular region is expressed as Wymax, the width in the direction of longitude of the rectangular region is expressed as Wx, and the width in the direction of latitude of the rectangular region is expressed as Wy, the following equations: Wx=Wxmax−Wxmin and Wy=Wymax−Wymin are provided, and the width in the direction of longitude of each mesh in the layer of level 0 is Wx/8, the width in the direction of latitude of each mesh in the layer of level 0 is Wy/8, the width in the direction of longitude of each mesh in the layer of level 1 is Wx/4, the width in the direction of latitude of each mesh in the layer of level 1 is Wy/4, the width in the direction of longitude of each mesh in the layer of level 2 is Wx/2, and the width in the direction of latitude of each mesh in the layer of level 2 is Wy/2.

Furthermore, in order to identify each mesh, mesh coordinates (X, Y) are provided for each mesh. 0, 1, 2, and . . . are provided, as mesh coordinates X, in turn to the meshes arranged from the left end to the right end, and 0, 1, 2, and . . . are provided, as mesh coordinates Y, in turn to the meshes arranged from the lower end to the upper end.

FIG. 3 shows an example of arbitrary regions which exist in the creation range, and shows a state in which arbitrary regions, such as regions A, B, C, D, E, and F, exist. Hereafter, the map information about each of meshes into which the creation range is divided is referred to as mesh information. Furthermore, for the sake of simplicity, storing the mesh information about a mesh in a regional map file will be described as “storing a mesh in a regional map file” hereafter, and a mesh included in an arbitrary region corresponding to a regional map file will be described as “a mesh of a regional map file” hereafter.

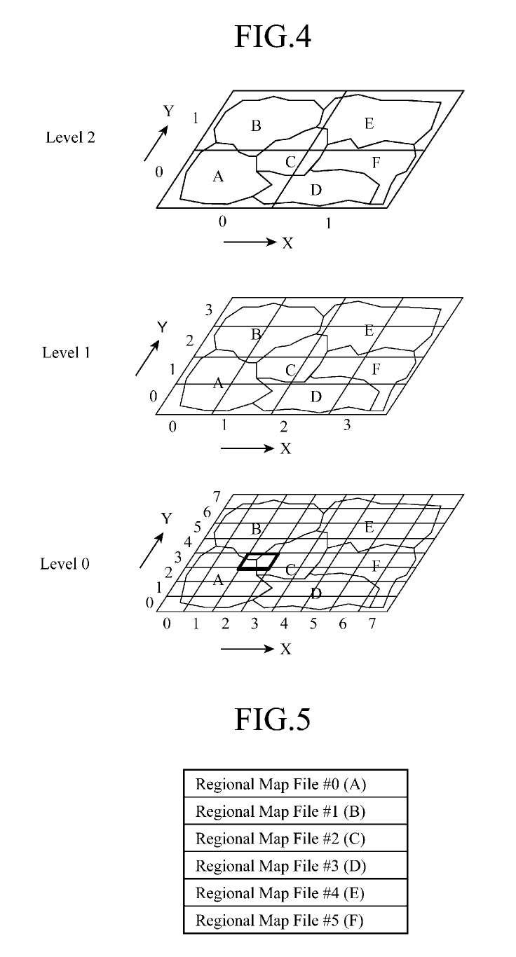

FIG. 4 is an example showing meshes in which the creation range of the map information divided into the meshes as shown in FIG. 2 are stored in the regional map files respectively corresponding to the arbitrary region A, B, C, D, E, and F. For example, in a case of a mesh, like the mesh (1, 1) in the layer of level 0, including only a part of the arbitrary region A, the mesh is stored only in the regional map file corresponding to the arbitrary region A. In contrast, in a case of a mesh, like the mesh (2, 3) in the layer of level 0, including parts of the three arbitrary regions A, B, and C, the mesh is stored in all the regional map files respectively corresponding to the arbitrary region A, B, and C. By performing this allocation on all the meshes of the creation range of the map information, each regional map file is formed in such a way to include all the meshes in each of which at least a part of the arbitrary region corresponding to the regional map file is included.

In the map information storage unit 4, regional map files each showing the map information of a corresponding arbitrary region in each hierarchical layer are stored while being respectively brought into correspondence with the arbitrary regions included in the creation range of the map information, and mesh management information for managing the meshes in each hierarchical layer is also stored.

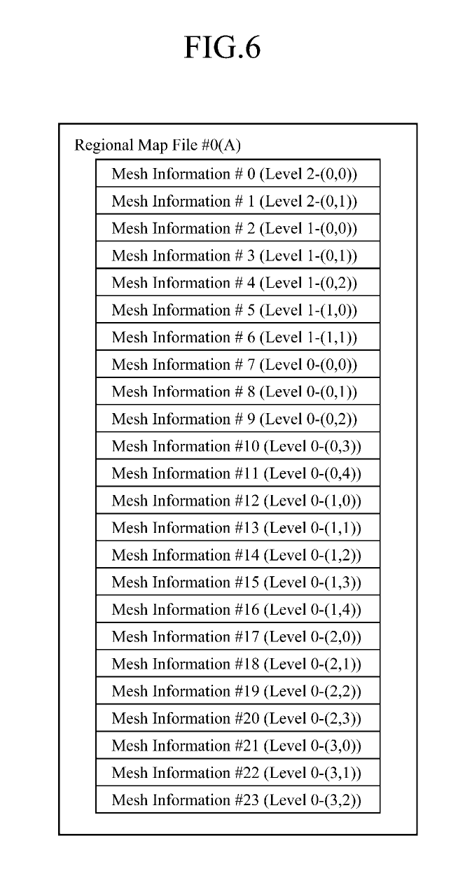

FIGS. 5 and 6 are examples of the regional map files whose pieces of information about the hierarchical layers and the divided regions are stored in the map information storage unit 4. In each of the regional map files, all the meshes each including a part of the corresponding arbitrary region in the corresponding one of all the hierarchical layers are stored. In the example shown in FIG. 5, the regional map files #0 (A) to #5 (F) are disposed while being brought into correspondence with the arbitrary regions A to F, respectively. FIG. 6 shows an example of the regional map file #0 (A) shown in FIG. 5, and the regional map file #0 (A) consists of all the meshes each including a part of the arbitrary region A in the corresponding one of the layers of level 2, level 1, and level 0 shown in FIG. 4. More specifically, the regional map file #0 (A) consists of the pieces of mesh information about the meshes (0, 0) and (0, 1) in the layer of level 2, the meshes (0, 0), (0, 1), (0, 2), (1, 0), and (1, 1) in the layer of level 1, and the meshes (0, 0), (0, 1), (0, 2), (0, 3), (0, 4), (1, 0), (1, 1), (1, 2), (1, 3), (1, 4), (2, 0), (2, 1), (2, 2), (2, 3), (3, 1), (3, 2), and (3, 3) in the layer of level 0.

To each of the regional map files, a filename which consists of a character string for identifying the arbitrary region corresponding to the regional map file, and information showing the version of the creation range of the arbitrary region is set. For example, the filename of the regional map file #0 (A) is created as “A001.MAP” when the version of the creation range is Ver.1, and, when the creation range changes and the version of the creation range is updated to Ver.2, is created as “A002.MAP”. By thus adding the version of the creation range to the filename as a method of changing the filename, version management of the creation range can be carried out.

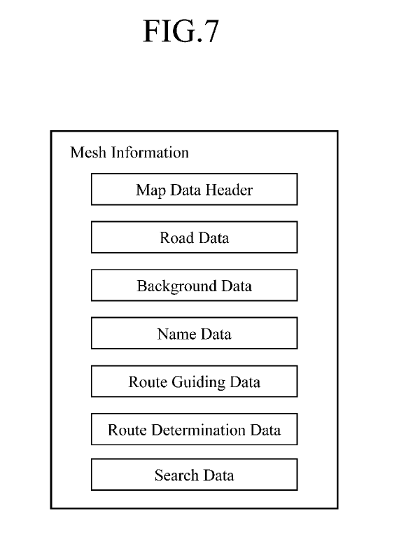

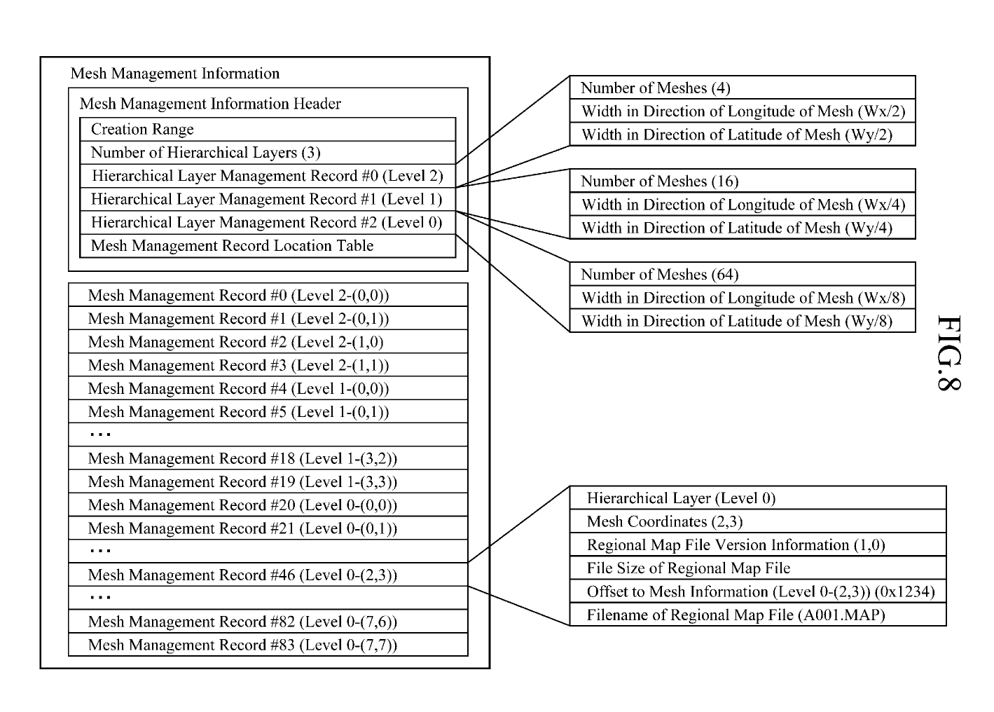

FIG. 7 shows an example of each mesh information included in the regional map file shown in FIG. 6. Each mesh information includes road data used for map matching, a display of roads, etc., background data for displaying map backgrounds, such as a river and a sea, name data for displaying names, such as place names, route guiding data for route guiding, route determination data for route determination, and search data for searching for facilities or the like, and also includes map data headers showing the locations and the data sizes of the various data.

FIG. 8 shows an example of the mesh management information stored in the map information storage unit 4 in the case in which the hierarchical layers and the divided regions are constructed as shown in FIG. 4. The mesh management information is comprised of a mesh management information header and mesh management records which are disposed while being brought into correspondence to the meshes in each of the hierarchical layers, respectively.

The mesh management information header is comprised of the creation range, the number of hierarchical layers, hierarchical layer management records which are disposed while being brought into correspondence the hierarchical layers, respectively, and a mesh management record position table showing the locations of the mesh management records in the mesh management information. The creation range is comprised of the longitude of the left end of the rectangular region, the longitude of the right end of the rectangular region, the latitude of the lower end of the rectangular region, and the latitude of the upper end of the rectangular region. Each of the hierarchical layer management records is comprised of the number of meshes in the corresponding hierarchical layer, the width of each mesh in the direction of longitude, and the width of each mesh in the direction of latitude.

Each of the mesh management records is comprised of the hierarchical layer and the mesh coordinates of the mesh, the version information about the version of the mesh information (the version information about the version of a regional map file), the size of the mesh information (the size of the regional map file), the offset from the head of the regional map file to the mesh information, and the filename of the mesh information (the filename of the regional map file). The filename corresponds to “file identifying information” in accordance with the present invention, and the offset corresponds to “mesh storage location information” in accordance with the present invention. In order to facilitate searches, the mesh management records are sorted according to the hierarchical layers and the mesh coordinates.

Although the information about the mesh (2, 3) in the layer of level 0 is included in all the regional map files respectively corresponding to the arbitrary regions A, B, and C because the mesh includes a part of each of the arbitrary regions A, B, and C in the mesh management information shown in FIG. 8, the mesh management record corresponding to the latest version of the mesh information among the pieces of mesh information stored in the arbitrary regions A, B, and C is used as the mesh management record of the mesh.

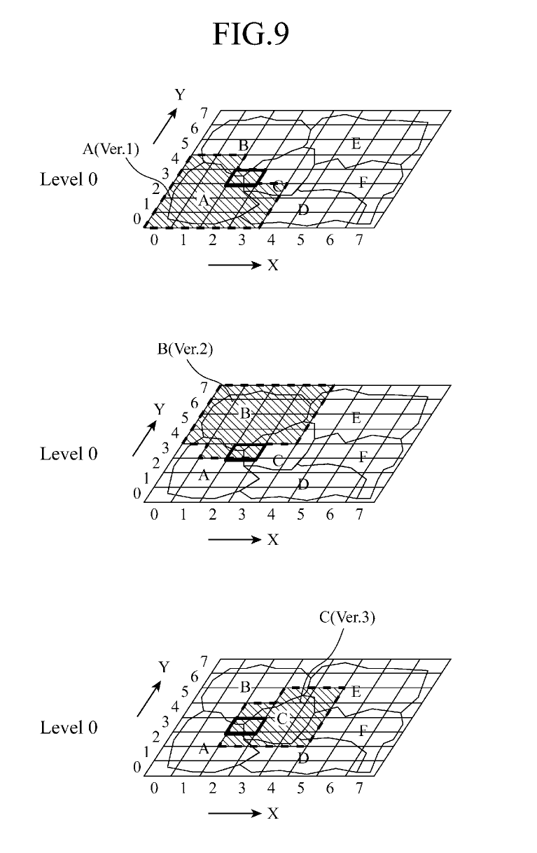

For example, in an example shown in FIG. 9, when the version of the regional map file corresponding to the arbitrary region A is Ver.1, the version of the regional map file corresponding to the arbitrary region B is Ver.2, and the version of the regional map file corresponding to the arbitrary region C is Ver.3, a value which makes reference to the meshes associated with the arbitrary region C is set to the mesh management record of the mesh (2, 3) in the layer of level 0 and Ver.3 is set as the version information of the mesh.

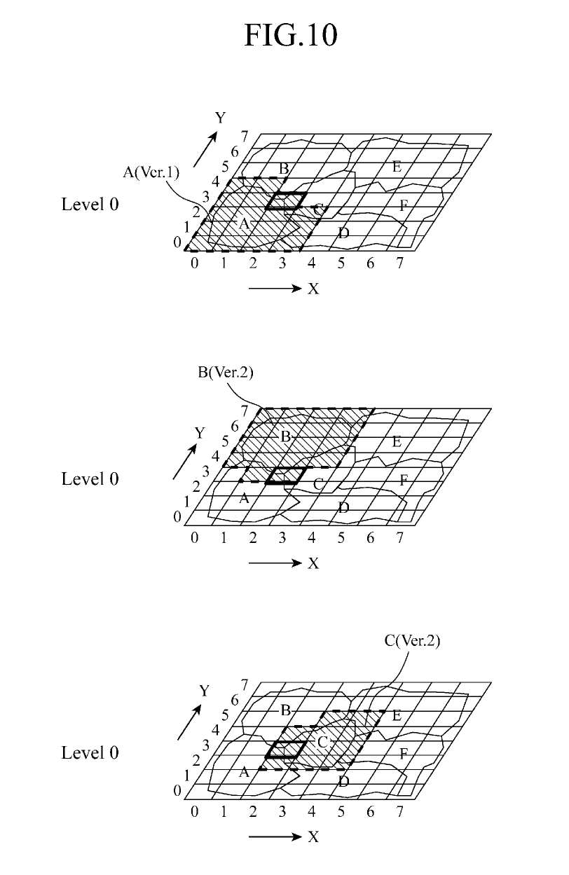

Furthermore, in an example shown in FIG. 10, when the version of the regional map file corresponding to the arbitrary region A is Ver.1, the version of the regional map file corresponding to the arbitrary region B is Ver.2, and the version of the regional map file corresponding to the arbitrary region C is Ver.2, a value which makes reference to the previously updated arbitrary region in the meshes associated with the arbitrary region B or C is set to the mesh management record of the mesh (2, 3) in the layer of level 0, and Ver.2 is set as the version information of the mesh.

When a required hierarchical layer of map information and a required range of map information are specified, the mesh coordinates of a required mesh can be easily computed from the creation range, the width in the direction of longitude of each mesh in the required hierarchical layer, and the width of the direction of latitude of each mesh in the required hierarchical layer in the mesh management information header shown in FIG. 8. Assuming that the mesh (2, 3) in the layer of level 0 is acquired as the required hierarchical layer and the required mesh, the map information processing device can easily acquire the mesh information about the mesh by searching through the mesh management information shown in FIG. 8 to retrieve the mesh management record #46 (level 0-(2, 3)) whose hierarchical layer is the one of level 0 and whose mesh coordinates are (2, 3), and then using the filename of a regional map file, the offset information about the offset from the head of the regional map file, and the size of the mesh information which are set in the mesh management record.

Next, the details of the update information for use in the map information processing device in accordance with Embodiment 1 will be explained. The update information is used for updating the map information about all the hierarchical layers of an arbitrary region which a user desires to update, the desired map information being included in the map information stored in the map information storage unit 4, and is provided for the user while being stored in a memory card.

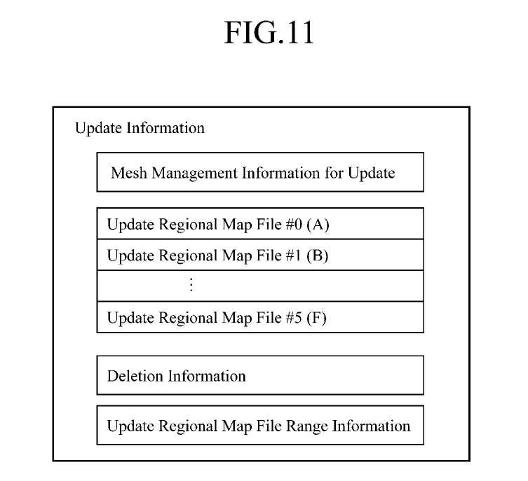

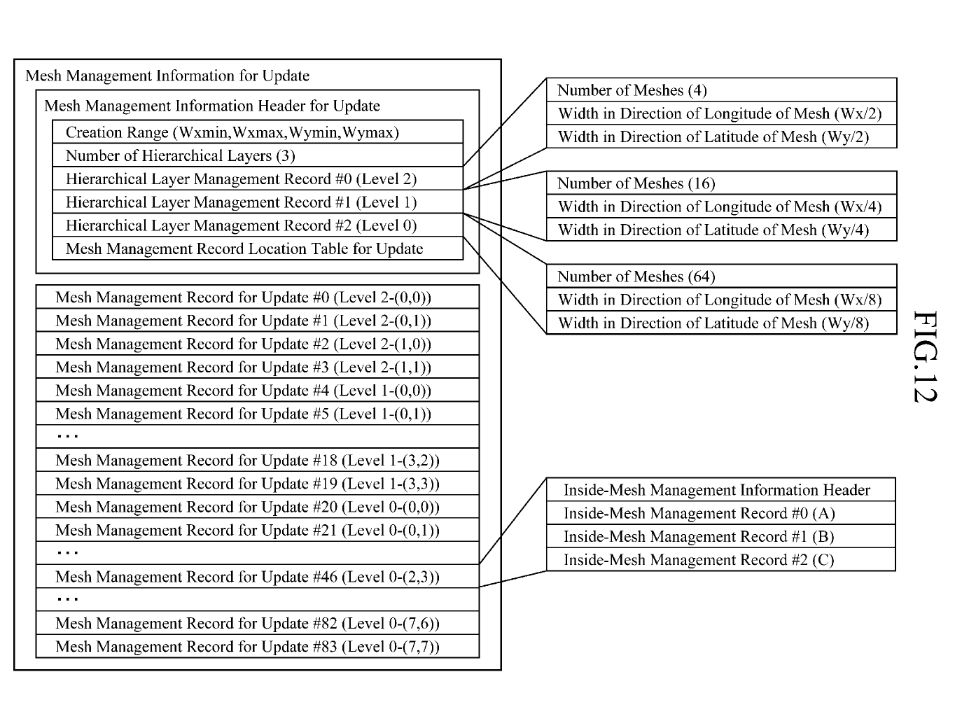

FIG. 11 shows an example of the update information. The update information is comprised of mesh management information for update, update regional map files, deletion information for deleting an unnecessary regional map file, and update regional map file range information for identifying meshes which should be updated at a high speed.

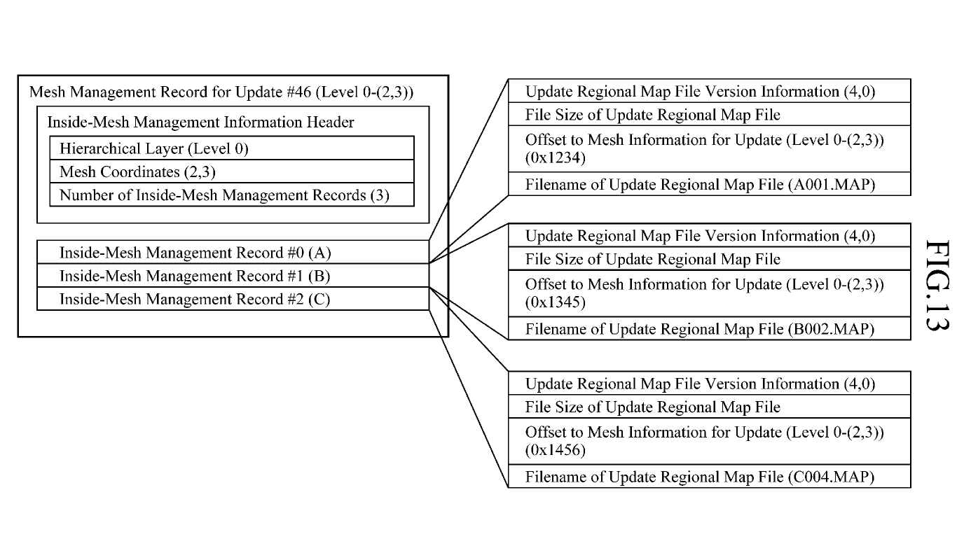

FIG. 12 shows an example of the mesh management information for update included in the update information. The mesh management information for update is comprised of a mesh management information header for update, and mesh management records for update which are disposed while being respectively brought into correspondence with the meshes in each hierarchical layer. The mesh management information header for update has the same data structure as the mesh management information header shown in FIG. 8.

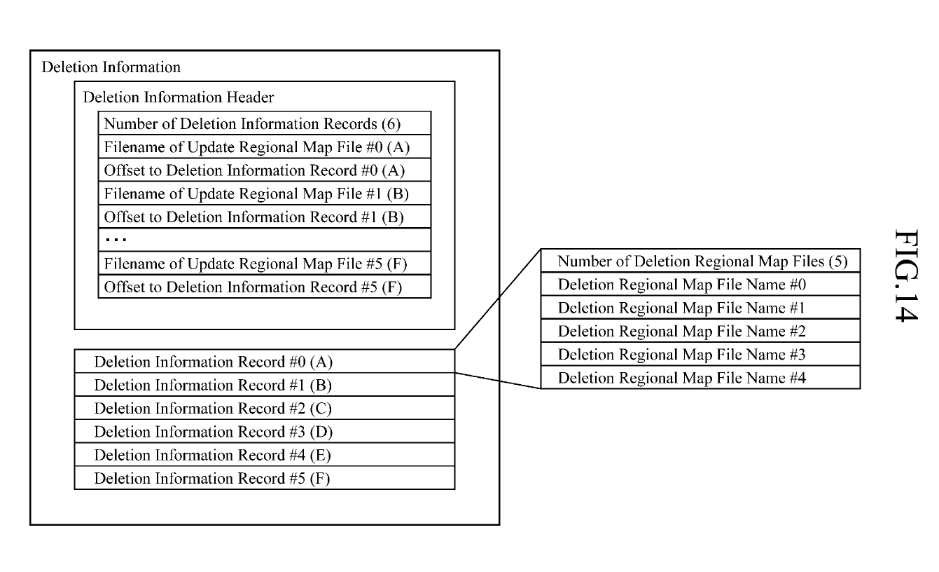

Each mesh management record for update is comprised of an inside-mesh management information header and inside-mesh management records, unlike each mesh management record shown in FIG. 8. FIG. 13 shows an example of each mesh management record for update. The inside-mesh management information header is comprised of information showing the hierarchical layer, the coordinates of the mesh, and the number of inside-mesh management records. The number of inside-mesh management records corresponds to the number of arbitrary regions each of which is partially included in the mesh.

Each inside-mesh management record is comprised of the version information about the version of the update regional map file in which the corresponding mesh information is stored, the offset from the head of the update regional map file to the corresponding mesh information for update, the size of the mesh information (the file size of the update regional map file), and the filename of the update regional map file in which the mesh information is stored. The offset corresponds to “mesh storage location information for update” in accordance with the present invention, and the filename of the update regional map file corresponds to “file identifying information” in accordance with the present invention. In order to facilitate searches, the mesh management records are sorted according to the hierarchical layers and the mesh coordinates.

Furthermore, each update regional map file has the same structure as each regional map file. When there is no change in the creation range of a regional map file, the filename of a corresponding update regional map file is set in such a way as to have the same filename as that of the immediately preceding version number having the creation range. In contrast, when the creation range differs from that of the immediately preceding map information version, the version number of the creation range in the filename is incremented and the update regional map file is created in such a way as to have a different filename.

For example, when there is no change in the creation range of the regional map file #0 (A) between Ver.1 and Ver.2 and the filename of Ver.1 is “A001.MAP”, “A001.MAP” is also set to the filename of the regional map file of Ver.2. Furthermore, when the creation range of the regional map file #0 (A) differs between Ver.1 and Ver.2, and the filename of Ver.1 is “A001.MAP”, the version of the creation range is raised by one, and “A002.MAP” is set to the filename of the regional map file of Ver.2.

When the creation range of an update regional map file is the same as that of a corresponding regional map file stored in the map information storage unit 4, although the regional map file stored in the map information storage unit 4 is overwritten with the update regional map file by changing the filename by changing the creation range of the update regional map file, any problem does not arise because the regional map file stored in the map information storage unit 4 is not referred to after the update.

For example, when there is no change in the creation range, the filename of Ver.1 corresponding to the regional map file #0 (A) is “A001.MAP” and the filename of Ver.2 is “A001.MAP”, the regional map file is overwritten with the update regional map file during the update, and the map information processing device is in a state in which “A001.MAP” of Ver.2 is stored in the map information storage unit 4. Because what is necessary is just to copy the update regional map file and overwrite the regional map file with this copy, instead of rewriting the contents of the regional map file, when the creation range of the regional map file does not change, each regional map file can be updated to a corresponding update regional map file by simply replacing the regional map file with the update regional map file.

When the creation range of an update regional map file differs from the creation range of a corresponding regional map file stored in the map information storage unit 4, making a copy of the update regional map file in the map information storage unit 4 results in both the update regional map file and the regional map file corresponding to the single arbitrary region remaining in the map information storage unit because the update regional map file and the regional map file stored in the map information storage unit 4 have different filenames. However, even in a case in which there exist pieces of mesh information which have been stored only in the regional map file stored in the map information storage unit 4 due to a change of the creation range of the regional map file before the update, these pieces of mesh information are not lost due to a change in the filename.

For example, when the creation range is changed, the filename of Ver.1 corresponding to the regional map file #0 (A) is “A001.MAP” and the filename of Ver.2 is “A002.MAP”, and the filename differs during the update. Therefore, the regional map file is not overwritten with the update regional map file, and the map information processing device is in a state in which the two regional map files: “A001.MAP” of Ver.1 and “A002.MAP” of Ver.2 are stored in the map information storage unit 4. As a result, in a case in which the region to be updated is an administrative district, for example, the map information processing device becomes able to carry out the updating process without being conscious of the creation range of the already stored map information even when the shape of the region which is an administrative district changes due to integration of the administrative district with another administrative district, division of the administrative district, or the like. Furthermore, even in such a case, the map information processing device simply copies the update regional map file to the map information storage unit 4.

Also in a case in which an old regional map file is left behind due to a change of the creation range of a corresponding update regional map file, deletion information is created and is provided as update information when the regional map files which are not referred to any longer in the updated mesh management information have become known in advance.

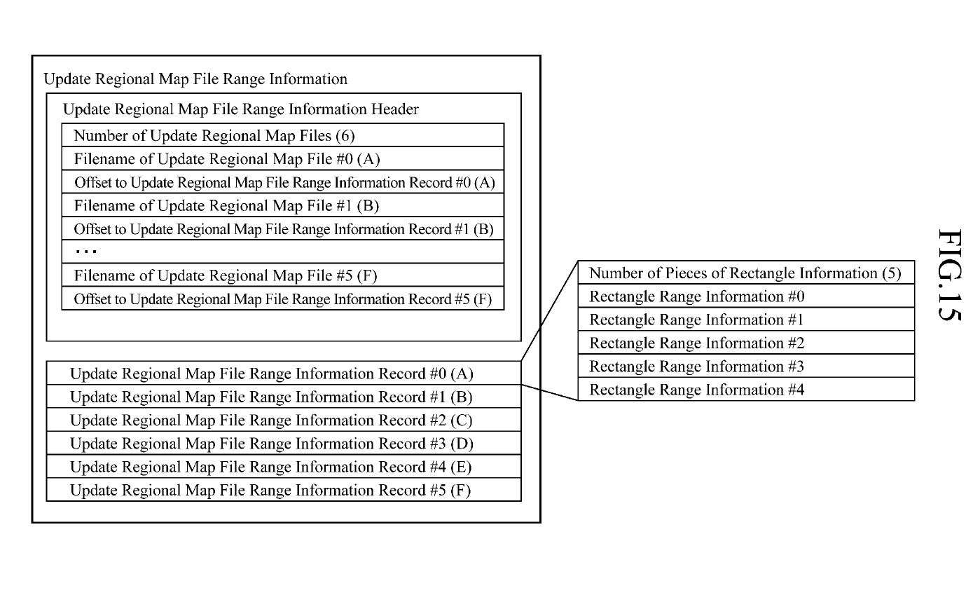

FIG. 14 shows an example of the deletion information included in the update information. The deletion information is comprised of a deletion information header and deletion information records. The deletion information header is comprised of the number of update regional map files included in the update information (the number of deletion information records), the filenames of the plurality of update regional map files whose number is equal to the number of update regional map files, and the offset to the deletion information record corresponding to each update regional map file. Each deletion information record is comprised of the number of regional map files to be deleted, and the filenames of the plurality of regional map files to be deleted whose number is equal to the number of regional map files to be deleted (the names of the regional map files to be deleted).

Because there is a case in which some regional map files which are not referred to any longer in the updated mesh management information reference have become unknown in advance, the processor 5 acquires both the filename of the regional map file set in each mesh management record included in the updated mesh management information, and the filename of each regional map file stored in the map information storage unit 4 to compare them with each other. When identifying a regional map file which is not referred to from any mesh management record, the processor deletes the regional map file.

Because a regional map file is deleted in this way after it is judged that the regional map file has not been actually referred to, any regional map file which has not been referred to can be deleted surely regardless of the state of the regional map file held by the map information processing device 4. As a result, a reduction in the data volume can be achieved. A search for a regional map file which has not been referred to any longer can be made immediately after the update or by using an idling time of the processor 5.

FIG. 15 shows an example of the update regional map file range information included in the update information. The update regional map file range information is comprised of pieces of information showing the creation ranges of the update regional map files. The processor 5 searches through the mesh management records for update while limiting its search range to the ranges shown by the update regional map file range information, and rewrites the mesh management records by using the mesh management records for update associated with a region specified from the input unit 1. Using this structure, the processor can determine the range of meshes included in the update regional map file selected from the pieces of mesh management information for update, and can eliminate an additional determination of whether or not a mesh outside the range should be updated. As a result, the update process can be speeded up.

For example, the update regional map file range information can consist of information showing the outside shape of an aggregate of meshes included in each update regional map file. By thus determining the range of meshes included in a regional map file for update selected from the mesh management information for update, the processor can eliminate an additional determination of whether or not a mesh outside the range should be updated. As an alternative, the update regional map file range information can consist of information showing either a rectangle or an aggregate of rectangles outlining the outside shape of an aggregate of meshes included in each update regional map file. By thus adding the information showing either a rectangle or an aggregate of rectangles as the information showing the range, and then performing a determination of whether or not each mesh is inside or outside the rectangle or the aggregate of rectangles, the processor can eliminate an additional determination of whether or not a mesh outside the range should be updated, and can identify any mesh in which a part of the region to be updated can be included at a high speed.

The update regional map file range information is comprised of an update regional map file range information header and update regional map file range information records. The update regional map file range information header is comprised of the number of update regional map files, the filename of each update regional map file, and the offset to the update regional map file range information record corresponding to each update regional map file.

Each of the update regional map file range information records is comprised of the number of plural pieces of rectangle information and a plurality of pieces of rectangle range information whose number is equal to the number of plural pieces of rectangle information. Each rectangle range information is comprised of the latitude of the corresponding rectangle's upper end, the latitude of the rectangle's lower end, the longitude of the rectangle's right end, and the longitude of the rectangle's left end.

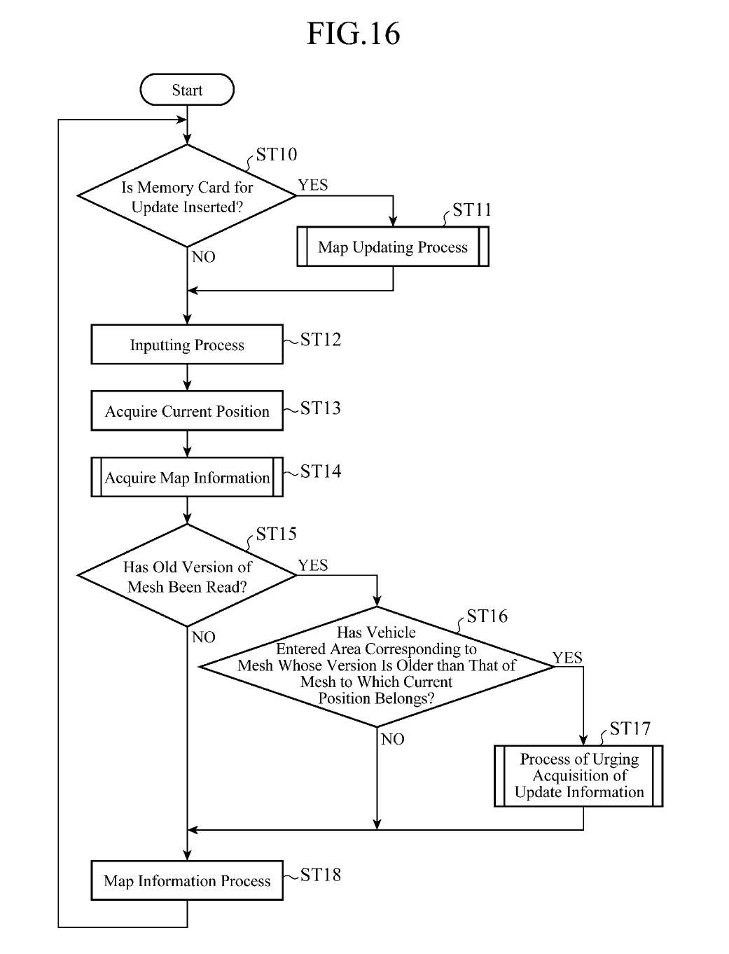

Next, the operation of the map information processing device in accordance with Embodiment 1 of the present invention which is constructed as above will be explained with reference to a flow chart shown in FIG. 16, focusing on main processing.

When the map information processing device is started and the main processing is started, whether or not a memory card for update is inserted into the map information processing device is checked to see first (step ST10). More specifically, the processor 5 checks to see whether or not a memory card for update is inserted into the update information acquiring unit 3 according to a signal sent thereto from this update information acquiring unit 3. When it is determined in this step ST10 that a memory card for update is not inserted into the update information acquiring unit, the sequence is advanced to step ST12.

In contrast, when it is determined in step ST10 that a memory card for update is inserted into the update information acquiring unit, a map updating process is carried out (step ST11). More specifically, the update information acquiring unit 3 reads the update information stored in the memory card for update inserted into the device, and sends the update information to the processor 5. The processor 5 updates the map information stored in the map information storage unit 4 by using the update information sent thereto from the update information acquiring unit 3. The map updating process performed in this step ST11 will be explained later in detail. After that, the sequence is advanced to step ST12.

An input process is performed in step ST12. More specifically, a user inputs a command to the map information processing device from the input unit 1. For example, the user operates the input unit 1 to input a command for specifying the display scale of a map, inputting the user's destination, starting a route determination, or the like. The input unit 1 creates a command signal according to the user's operation or command, and sends the command signal to the processor 5. The processor 5 receives the command signal inputted from the input unit 1.

The current position is then acquired (step ST13). More specifically, the position detecting unit 2 detects the current position of the vehicle, and sends this current position to the processor 5 as position information. The processor 5 acquires the position information from the position detecting unit 2.

Map information is then acquired (step ST14). More specifically, the processor 5 acquires the mesh information about the meshes in the required range in the required hierarchical layer which is determined by both the command inputted in step ST12 and the position information acquired in step ST13 from the map information storage unit 4. The process of acquiring the map information which is performed in this step ST14 will be explained later in detail.

Next, whether or not an old version of mesh has been read is checked to see (step ST15). More specifically, the processor 5 checks to see whether the processor has read an old version of mesh by checking to see the version of the meshes in the required range in the required hierarchical layer which the processor has acquired in step ST14. When it is determined in this step ST15 that any old version of mesh has not been read, that is, that the read meshes have a version equal to or newer than that of the mesh corresponding to the area including the current position, the sequence is advanced to step ST18.

In contrast, when it is determined in step ST15 that an old version of mesh has been read, that is, that the read meshes have a mesh having a version older than that of the mesh corresponding to the area including the current position, whether the vehicle has entered the area corresponding to a mesh having a version older than that of the mesh corresponding to the area including the current position is checked to see (step ST16). More specifically, whether the vehicle has entered the area corresponding to a mesh having a version older than that of the mesh corresponding to the area including the current position, the mesh having an older version being included in the meshes of the required range in the required hierarchical layer which are acquired in step ST14, is checked to see.

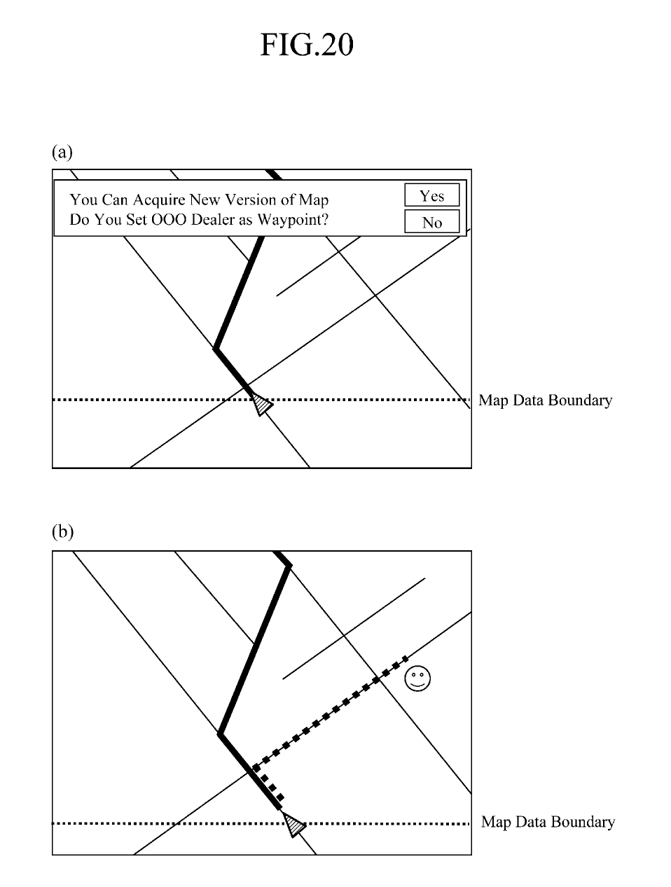

When it is determined in this step ST16 that the vehicle has not entered any area corresponding to a mesh having aversion older than that of the mesh corresponding to the area including the current position, the sequence is advanced to step ST18. In contrast, when it is determined in step ST16 that the vehicle has entered an area corresponding to a mesh having a version older than that of the mesh corresponding to the area including the current position, a process of urging acquisition of update information is then performed (step ST17). In this step ST17, a message for inquiring whether or not to set a point (a dealer or a store) where the user can acquire update information as a waypoint, as shown in, for example, FIG. 20(a), is outputted to the display screen. Furthermore, as shown in, for example, FIG. 20(b), a route leading to a point where update information can be acquired is searched for, and the route which has been searched for is additionally superimposed on an on-screen route. This process of urging acquisition of map information which is carried out in step ST17 will be explained later in detail. After that, the sequence is advanced to step ST18.

A map information process is carried out in step ST18. More specifically, the processor 5 performs the map information process which is determined by both the command inputted in step ST12 and the position information acquired in step ST13 by using the map information acquired in step ST14. Then, the sequence is returned to step ST10 and the above-mentioned processes are repeated.

In general, although a case in which the continuity of map data is not necessarily guaranteed at a boundary between old map data and new map data due to a secular change of map data or disagreement between versions can be considered, the processor 5 carries out the above-mentioned processes to display both the mesh corresponding to the area to which the current position detected by the position detecting unit 2 belongs, and meshes having a version older than that of the mesh corresponding to the area to which the current position belongs on the output unit 6, and, when determining a route leading to a mesh having a version older than that of the mesh corresponding to the area to which the current position belongs or when the vehicle has entered an area corresponding to a mesh having a version older than that of the mesh corresponding to the area to which the current position belongs, can display information to that effect on the output unit 6. Therefore, the map information processing device can call attention to the user, and notify the user that he or she can acquire new map data.

In this case, the processor 5 can be constructed in such a way as to acquire the version information of any mesh currently displayed on the output unit 6 from the version information of each mesh stored in the mesh management information. According to this structure, because the map information processing device can use the version information of each mesh included in the management information when the vehicle is in the vicinity of a boundary between an area corresponding to an old-version mesh and an area corresponding to a new-version mesh, the map information processing device can carry out the determination without providing nodes or links with any boundary information.

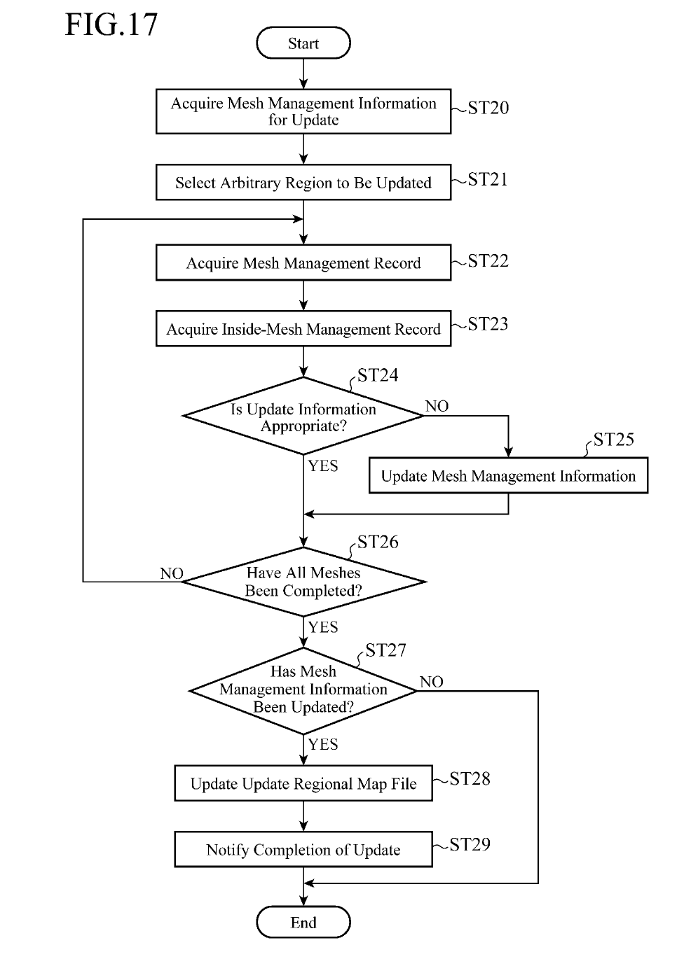

Next, the details of the map updating process performed in above-mentioned step ST11 will be explained with reference to a flow chart shown in FIG. 17.

In this map updating process, the mesh management information for update is acquired first (step ST20). More specifically, the update information acquiring unit 3 reads the mesh management information for update in a memory card inserted into the map information processing device, and sends the mesh management information for update to the processor 5. As a result, the processor 5 acquires the mesh management information for update.

An arbitrary region which is to be updated is then selected (step ST21). More specifically, the user specifies an arbitrary region which he or she desires to update from the input unit 1. As a result, the processor 5 selects the arbitrary region which is specified by the user from among the update regional map files included in the update information.

A mesh management record is then acquired (step ST22). More specifically, the processor 5 acquires update regional map file range information corresponding to the arbitrary region which the user is going to update, and also acquires a mesh management record which is included in the range and which show a mesh corresponding to the arbitrary region which the user is going to update from among the mesh management information.

Inside-mesh management records are then acquired (step ST23). More specifically, the processor 5 acquires the pieces of inside-mesh management information corresponding to the arbitrary region which the user is going to update from the mesh management record for update corresponding to the mesh management record acquired in step ST22. When no inside-mesh management records corresponding to the arbitrary region exist, the sequence is advanced to step ST26, though not shown in the flow chart.

Whether or not the update information is appropriate is then checked to see (step ST24). More specifically, the processor 5 compares the version number of the mesh management record acquired in step ST22 with the version numbers of the inside-mesh management records acquired in step ST23 to check to see whether or not the update information is appropriate. When it is determined in this step ST24 that the update information is appropriate, that is, when the version of the update information is equal to or older than the versions of the inside-mesh management records, the sequence is advanced to step ST26.

In contrast, when it is determined in step ST24 that the update information is not appropriate, that is, when the version of the update information is newer than the versions of the inside-mesh management records, an update of the mesh management information is performed (step ST25). More specifically, the processor 5 rewrites the mesh management record showing the mesh in the mesh management information stored in the map information storage unit 4 with the values held by the inside-mesh management records.

Whether or not the process on all the meshes has been completed is then checked to see (step ST26). More specifically, whether or not the process has been performed on all the meshes which satisfy the range information shown by the update regional map file range information is checked to see. When it is determined in this step ST26 that the process on all the meshes has not been completed, the sequence is returned to step ST22 and the above-mentioned process is repeated.

In contrast, when it is determined in step ST26 that the process on all the meshes has been completed, whether or not the mesh management information has been updated is then checked to see (step ST27). When it is determined in this step ST27 that the management information has not been updated, that is, when the updating process has not been performed on all the meshes which satisfy the range information shown by the update regional map file range information in step ST25, the map updating process is ended.

In contrast, when it is determined in step ST27 that the mesh management information has been updated, that is, when the updating process has been performed on at least one mesh management record, an update of the update regional map file is then performed (step ST28). More specifically, the update regional map file which the user has selected is copied to the map information storage unit 4. In this case, when there is a regional map file having the same name as the update regional map file in the map information storage unit, the regional map file is overwritten with the update regional map file, whereas when there is no regional map file having the same name as the update regional map file in the map information storage unit, the update regional map file is copied to the map information storage unit, just as it is.

An update completion notification is then provided (step ST29). More specifically, the processor 5 sends and displays a message showing that the updating process has been completed to the output unit 6 to notify the user that the updating process has been completed, and, after that, ends the map updating process.

By rewriting the mesh management information and the regional map file stored in the map information storage unit 4 with the update information acquired from the memory card in the above-mentioned way, the map information processing device can update the map information to the newest version and can easily update the map information and the management information about meshes including an arbitrary region.

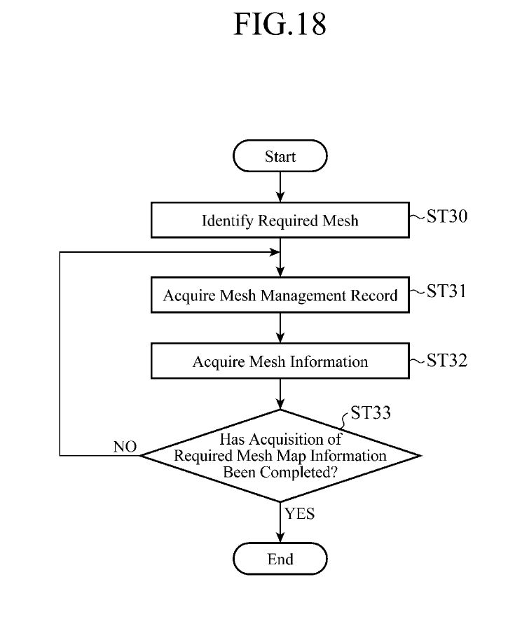

Next, the details of the map information acquiring processing performed in above-mentioned step ST14 will be explained with reference to a flow chart shown in FIG. 18.

In the map information acquiring processing, the required meshes are identified first (step ST30). More specifically, the processor 5 identifies the meshes existing in the required range in the required hierarchical layer which is determined by both the command inputted in step ST12 of the main processing and the position information acquired in step ST13, and refers to the creation range, the width in the direction of longitude of each mesh in the required hierarchical layer, and the width in the direction of latitude of each mesh in the required hierarchical layer, which are included in the mesh management information header of the mesh management information stored in the map information storage unit 4, to calculate the mesh coordinates of each of the required meshes.

For example, in a case in which the display scale of the map is specified via the input unit 1 and the hierarchical layers and the divided regions are constructed as shown in FIG. 4, when the required hierarchical layer is the one of level 0, the center of the map display is the upper right corner of the mesh coordinates (2, 3), the center's longitude and latitude are X=Wxmin+(Wx/8)*3 and Y=Wymin+(Wy/8)*4, respectively, and the longitudes and latitudes of the required range are X−(Wx/16) to X+(Wx/16) and Y−(Wy/16) to Y+(Wy/16), respectively, the processor refers to the creation range of the mesh management information header and the hierarchical layer management record #2 shown in FIG. 8, subtracts Wxmin and Wymin from the longitudes and latitudes of the required range, respectively, and divides the subtraction results by Wx/8 and Wy/8 (the remainder is omitted), respectively, to acquire (2, 3), (3, 3), (2, 4), and (3, 4) as the mesh coordinates of the required meshes.

The mesh management records are then acquired (step ST31). More specifically, the processor 5 searches through the mesh management information stored in the map information storage unit 4 to acquire the mesh management records located in the required hierarchical layer and having the required mesh coordinates which are acquired in step ST30. For example, in a case in which the required hierarchical layer is the one of level 0 and the mesh coordinates are (2, 3), the mesh management record (level 0-(2, 3)) shown in FIG. 8 is acquired.

The mesh information is then acquired (step ST32). More specifically, the processor 5 acquires the mesh shown by one mesh management record acquired in step ST31 from the regional map files stored in the map information storage unit 4.

Whether or not the acquisition of the required pieces of mesh map information has been completed is then checked to see (step ST33). More specifically, the processor 5 checks to see whether the processes insteps ST31 and ST32 have been performed on all the required meshes in the required hierarchical layer, which are identified in step ST30. When it is determined in this step ST33 that the acquisition of the required pieces of mesh map information has not been completed, the sequence is returned to step ST31 and the above-mentioned processes are repeated.

In contrast, when, in step ST33, determining that the acquisition of the required pieces of mesh map information has been completed, the processor recognizes that the processor has acquired all the pieces of mesh map information about the required meshes in the required hierarchical layer, and ends the map information acquiring processing. At the time when the map information acquiring processing is ended, the processes in steps ST31 to ST35 are performed on each of the meshes having the mesh coordinates (2, 3), (3, 3), (2, 4), and (3, 4) in the layer of level 0, and the pieces of mesh map information about the required meshes are acquired, for example.

As mentioned above, the processor can easily acquire the pieces of mesh information about the required meshes from the map information storage unit 4 by referring to the mesh management information and the regional map files which are stored in the map information storage unit 4.

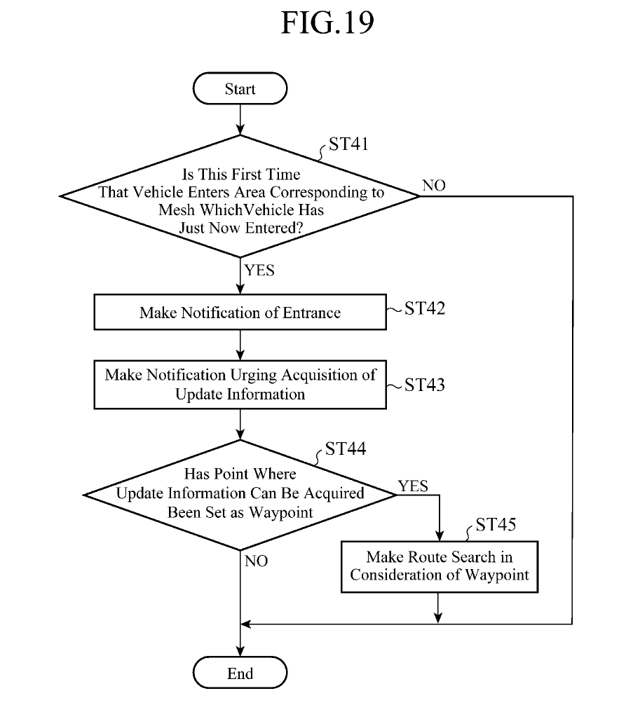

Next, the details of the process of urging acquisition of map information which is performed in above-mentioned step ST17 will be explained with reference to a flow chart shown in FIG. 19.

In the process of urging acquisition of map information, whether or not this is the first time that the vehicle enters the area corresponding to the mesh which the vehicle has just now entered is checked to see first (step ST41). More specifically, when it is determined in step ST16 of the above-mentioned main processing that the vehicle enters an area corresponding to a mesh having a version older than that of the mesh corresponding to the area in which the current position is included, whether or not the entrance is the first one is checked to see. When it is determined in this step ST41 that it is not the first time that the vehicle enters the area corresponding to the mesh which the vehicle has just now entered, the process of urging acquisition of map information is ended.

In contrast, when it is determined in step ST41 that it is the first time that the vehicle enters the area corresponding to the mesh which the vehicle has just now entered, the entrance is then notified (step ST42). More specifically, when the entrance to the area corresponding to the mesh in an old-version regional map file in a combination of regional map files is the first one in step ST16, the processor 5 uses both a sound output, a screen display, or a sound output and a screen display to notify the user that the vehicle has entered the area corresponding to the mesh having an old version.

A notification for urging acquisition of update information is then outputted (step ST43). More specifically, the processor 5 creates a display for urging acquisition of update information after, in step ST42, notifying the user that the vehicle has entered the area corresponding to the mesh having an old version. For example, the processor 5 creates a display for urging the user to set a location where the user can acquire update information as a waypoint.

Whether or not to set a point where the user can acquire update information as a waypoint is then checked to see (step ST44). More specifically, the processor 5 checks to see whether the user has selected a point where the user can acquire update information as a waypoint. When it is determined in this step ST44 that a point where the user can acquire update information is not set as a waypoint, the process of urging acquisition of map information is ended.

In contrast, when it is determined in step ST44 that a point where the user can acquire update information is set as a waypoint, a route search which takes the waypoint into consideration is then carried out (step ST45). More specifically, when a waypoint is set up in step ST44, the processor 5 carries out a route search with the point being set up as a waypoint, and ends the process of urging acquisition of map information.

As previously explained, the map information processing device in accordance with Embodiment 1 of the present invention can facilitate the management in the case of managing meshes including an arbitrary region by using a single file, and can update the map information in units of a regional map file including an arbitrary region. Furthermore, because the map information processing device can simply replace each regional map file with a new regional map file and can simply rewrite management information used for managing regional map files, the map information processing device enables the user to easily perform an updating operation.

### Embodiment 2

A map information processing device in accordance with Embodiment 2 of the present invention has the same structure as that in accordance with Embodiment 1 shown in FIG. 1.

Furthermore, map information for use in the map information processing device in accordance with Embodiment 2 is the same as that for use in the map information processing device in accordance with Embodiment 1.

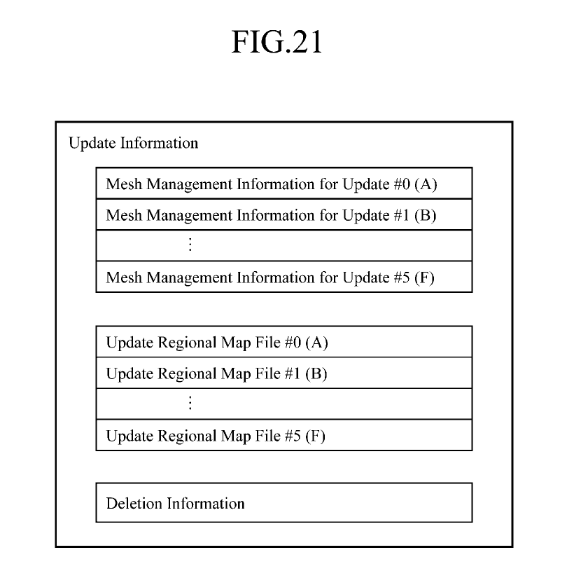

FIG. 21 shows an example of update information for use in the map information processing device in accordance with Embodiment 2. This update information is the one in which the update regional map file range information is removed from the update information for use in the map information processing device in accordance with Embodiment 1 (refer to FIG. 11), and mesh management information for update is disposed for each update regional map file. However, each mesh management record for update of the mesh management information for update has the same structure as each mesh management record stored in a map information storage unit 4, and only meshes stored in a corresponding regional map file are managed.

Next, the operation of the map information processing device in accordance with Embodiment 2 of the present invention constructed as above differs from that of the map information processing device in accordance with Embodiment 1 of the present invention only in the map updating process (step ST11) in the main processing of the map information processing device in accordance with Embodiment 1 shown in the flow chart of FIG. 16. Hereafter, the operation of the map information processing device in accordance with Embodiment 2 of the present invention will be explained, focusing on a portion different from that of the map information processing device in accordance with Embodiment 1.

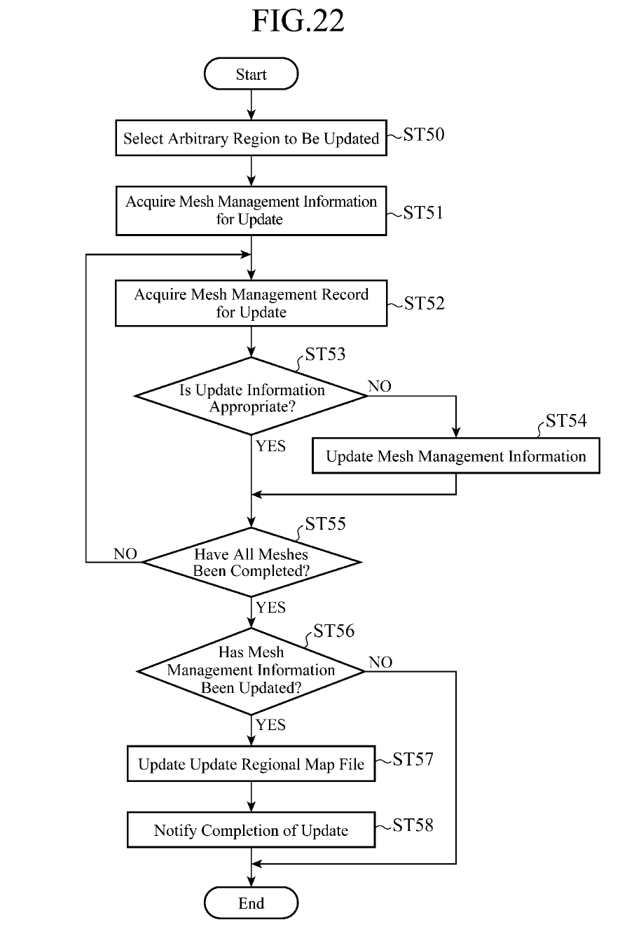

FIG. 22 is a flow chart showing the details of a map updating process carried out by the map information processing device in accordance with Embodiment 2.

In the map updating process, an arbitrary region to be updated is selected first (step ST50). More specifically, an update information acquiring unit 3 selects an arbitrary region which a user desires from update mesh management information included in update information stored in an inserted memory card. Mesh management information for update is then acquired (step ST51). More specifically, the update information acquiring unit reads the mesh management information for update which the user desires in step ST50 from the update information.

A mesh management records for update is then acquired (step ST52). More specifically, a processor 5 acquires mesh management records for update in order. Whether or not the update information is appropriate is then checked to see (step ST53). More specifically, the processor 5 compares the version number of the mesh management record for update acquired in step ST51 with the version number of a mesh management record corresponding to the mesh management record for update in the mesh management information to check to see whether or not the update is appropriate. When it is determined in this step ST53 that the update information is appropriate, that is, when the version of the update information is older than the version of the mesh management record in the mesh management information, the sequence is advanced to step ST55.

In contrast, when it is determined in step ST53 that the update information is appropriate, that is, when the version of the update information is newer than the version of the mesh management record in the mesh management information, an update of the mesh management information is performed (step ST54). More specifically, the processor 5 rewrites the mesh management record showing the mesh in the mesh management information stored in the map information storage unit 4 with the value stored in the mesh management record for update acquired in step ST51. After that, the sequence is advanced to step ST55.

Whether or not the process on all the meshes has been completed is then checked to see in step ST55. When it is determined in this step ST55 that the process on all the meshes has not been completed, that is, when the determination has not been performed on all the mesh management records for update held in the mesh management information for update, the sequence is returned to step ST52 and the above-mentioned process is repeated.

In contrast, when it is determined in step ST55 that the process on all the meshes has been completed, that is, when the determination has been performed on all the mesh management records for update, whether or not the management information has been updated is then checked to see (step ST56). When it is determined in this step ST56 that the management information has not been updated, that is, when the update process shown in step ST54 has not been performed on any of all the meshes which satisfy range information shown by update regional map file range information, the map updating process is ended.

In contrast, when it is determined in step ST56 that the management information has been updated, that is, when the updating process shown in step ST53 has been performed on at least one mesh, the update regional map file is then updated (step ST57). More specifically, the processor 5 copies the update regional map file which the user has selected to the map information storage unit 4. In this case, when there is a regional map file having the same name as the update regional map file in the map information storage unit, the regional map file is overwritten with the update regional map file, whereas when there is no regional map file having the same name as the update regional map file in the map information storage unit, the update regional map file is copied to the map information storage unit, just as it is.

An update completion notification is then provided (step ST58). More specifically, the processor 5 sends and displays a message showing that the updating process has been completed to an output unit 6 to notify the user that the updating process has been completed, and, after that, ends the map updating process.

As previously explained, because the map information processing device in accordance with Embodiment 2 of the present invention can simply replace each regional map file with a new regional map file and can simply rewrite management information used for managing regional map files, the map information processing device not only makes it easy for the user to perform an updating operation, but also eliminates the necessity to determine whether or not to update meshes other than the meshes included in the region to be updated by providing each regional map file for update with mesh management information for update.

In the map information processing device in accordance with any of above-mentioned Embodiments 1 and 2, although a memory card is used as the storage medium for storing the update information, the storage medium is not limited to the memory card and another storage medium can be alternatively used. Furthermore, although the map information processing device is constructed in such a way as to read the update information from the memory card by using a memory card reader, the map information processing device can be alternatively constructed in such a way as to acquire the update information from outside the map information processing device by using communications.

Furthermore, although the map information processing device is constructed in such a way as to provide each mesh with version information held by the mesh management information for update, the map information processing device can be alternatively constructed in such a way as to provide each mesh with version information held by a mesh management information header for update as long as the versions of all the regional map files included in the update information are the same.

Furthermore, although the map information processing device is constructed in such a way as to make all the meshes in the same hierarchical layer have the same size, the map information processing device can be alternatively constructed in such a way as to further divide each mesh in which the data size of the map information exceeds a predetermined value into smaller meshes.

Furthermore, although the map information processing device is constructed in such a way as to store the update information including information about a single arbitrary region as an update target in a single storage medium, the map information processing device can be alternatively constructed in such a way as to store update information including information about a plurality of arbitrary regions as an update target range in a single storage medium.

Furthermore, although the map information processing device is constructed in such a way as to use the latest version of an update regional map file as the update information, the map information processing device can be alternatively constructed in such a way as to use the difference between a version of an update regional map file which is stored in the map information storage unit 4 and the latest version of the update regional map file.

Furthermore, although the map information processing device is constructed in such a way as to sort the mesh management records in the mesh management information, the map information processing device can be alternatively constructed in such a way as to manage the mesh management records hierarchically by using a block set and blocks which are defined in the “map data storing format for automobile-car navigation system” (JISD 0810:2004).

Furthermore, although the map information processing device is constructed in such a way as to sort the update unit region mesh management records in the mesh management information for update, the map information processing device can be alternatively constructed in such a way as to manage the mesh management records hierarchically by using a block set and blocks which are defined in the “map data storing format for automobile-car navigation system” (JISD 0810:2004).

Furthermore, although the map information processing device is constructed in such a way as to store the size of the corresponding mesh information in each mesh management record and in each mesh management record for update, the map information processing device can be alternatively constructed in such a way as to refer to the size stored in each mesh information instead of storing the size of the corresponding mesh information in each mesh management record and in each mesh management record for update.

Furthermore, although the map information processing device is constructed in such a way as to store version information in each mesh management record for update, the map information processing device can be alternatively constructed in such a way as to provide each region to be updated with information showing the version, instead of storing version information in each mesh management record for update.

Furthermore, although the map information processing device is constructed in such a way as to store a filename as information identifying a file in each mesh management record and in each mesh management record for update, the map information processing device can be alternatively constructed in such a way as to add a region identifier for identifying each region to this region in advance, define the name which is determined uniquely from the region identifier as the filename of the corresponding regional map file or the corresponding update regional map file, and store the region identifier as the information for identifying the file in the corresponding mesh management record and in the corresponding mesh management record for update.

In addition, although the map information processing device in accordance with Embodiment 1 is constructed in such a way as to define a list of pieces of rectangle information outlining the outside shape as the update regional map file range information, the map information processing device can be alternatively constructed in such a way as to specify pieces of rectangle information by using a block set and blocks which are defined in the “map data storing format for automobile-car navigation system” (JISD 0810:2004). According to this structure, the map information processing device can use an existing resource effectively.

Furthermore, the map information processing device can be constructed in such a way as to notify the user only once that the moving object has entered an area corresponding to a mesh having a version older than that of the mesh corresponding to the area to which the current position of the moving object belongs even when the moving object has entered the area corresponding to the mesh having a version older than that of the mesh corresponding to the area to which the current position of the moving object belongs multiple times. According to this structure, in a possible case in which the moving object travels across a boundary between areas corresponding to regional maps multiple times, the map information processing device can prevent the user from becoming impossible to concentrate on the driving because of a troublesome notification which is made every time when the moving object travels across the boundary.

Furthermore, the map information processing device can be constructed in such a way as to notify the user by voice that the moving object has entered an area corresponding to a mesh having a version older than that of the mesh corresponding to the area to which the current position of the moving object belongs. According to this structure, the map information processing device can safely notify information to that effect to the driver at the time of travelling.

Furthermore, the map information processing device can be constructed in such a way as to notify the user that the moving object has entered an area corresponding to a mesh having a version older than that of the mesh corresponding to the area to which the current position of the moving object belongs by displaying information to that effect on the output unit. According to this structure, the map information processing device can notify information to that effect to the user even when the voice guidance is stopped.

Furthermore, the map information processing device can be constructed in such a way as to notify the user by voice that the moving object has entered an area corresponding to a mesh having a version older than that of the mesh corresponding to the area to which the current position of the moving object belongs while displaying information to that effect on the output unit. According to this structure, the map information processing device can notify the information to the user more certainly.

Furthermore, the map information processing device can be constructed in such away as to display a message for urging acquisition of an update regional map file about a region having an old version. According to this structure, even when an old version of map data include information different from the actual current road configuration, the map information processing device can update the map data to map data closer to the reality by acquiring new map data.

Furthermore, the map information processing device can be constructed in such a way as to check to see whether or not to acquire an update regional map file corresponding to an old version of a regional map file by using communications. According to this structure, the map information processing device can acquire the newest map data via communications as long as the map information processing device has a communication function, the map information processing device can always update the map information when the map information processing device is located in an environment where the map information processing device can secure communications.

Furthermore, the map information processing device can be constructed in such a way as to urge the user to set a point where the user can acquire an update regional map file as a waypoint. According to this structure, in a possible case in which the user drives the vehicle toward a store or a dealer where the user can acquire regional map information when the map information processing device does not have any communication function or when the user would like to save communication cost, the map information processing device can save the user from having to search for a store or a dealer where the user can acquire regional map information by urging the user to set the store or the dealer as a waypoint.

In addition, the map information processing device can be constructed in such a way as to superimpose and display a route leading to a point where the user can acquire an update regional map file. According to this structure, the map information processing device displays a route leading to a point where the user can acquire an update regional map file at the same time when the map information processing device creates a normal display of a route, thereby enabling the user to determine how long the user has to take a circuitous route to acquire the update regional map file from the visual information.

### INDUSTRIAL APPLICABILITY

The map information processing device in accordance with the present invention can be used in a car navigation device or the like which is required to easily perform management and an update of map information.

1. A map information processing device comprising:
a map information storage unit for storing map information about a map in which a creation region is managed while being divided into meshes, the map information including both regional map files each of which is provided for an arbitrary region, and mesh management information for managing said meshes;
an update information acquiring unit for acquiring update information for updating the map information stored in said map information storage unit; and
a processor for updating each of the regional map files of the map information stored in said map information storage unit by using the update information acquired by said update information acquiring unit,
wherein each of said regional map files stores mesh information which is map information about meshes including an arbitrary region corresponding to said each of said regional map files, said mesh management information includes mesh management records disposed in such a way as to respectively correspond to the meshes, each of said mesh management records includes file identifying information for identifying a regional map file including a corresponding mesh, version information about a version of the regional map file, and mesh storage location information showing a storage location of mesh information in the regional map file, and the file identifying information of a mesh management record corresponding to a mesh stored in a plurality of regional map files determines a latest version of a regional map file.

2. The map information processing device according to claim 1, wherein said map information processing device includes an input unit for inputting a command, the update information acquired by the update information acquiring unit includes mesh management information for update, and update regional map files which are regional map files for update, said mesh management information for update includes file specific information for identifying update regional map files, version information about versions of the update regional map files, and mesh storage location information for update showing a storage location of each mesh in each of the update regional map files, pieces of mesh storage location information for update each showing a mesh including a part of each of a plurality of arbitrary regions are held, the number of the pieces of mesh storage location information being equal to a number of update regional map files storing said mesh, and the processor replaces a regional map file of a region specified by said input unit with an update regional map file, and also rewrites the file identifying information, the version information, and the mesh storage location information which are included in the mesh management record of each mesh included in said region with corresponding pieces of information of the mesh management information for update corresponding to the regional map file specified by said input unit.

3. The map information processing device according to claim 1, wherein said map information processing device includes an input unit for inputting a command, the update information acquired by the update information acquiring unit includes mesh management information for update, and update regional map files which are regional map files for update, the mesh management information for update includes version information and mesh storage location information for update which are provided for each of the update regional map files, the version information showing a version of said each update regional map file and said mesh storage location information showing storage locations of meshes in said each update regional map file, and the processor replaces a regional map file of a region specified by said input unit with an update regional map file, and also rewrites the file identifying information, the version information, and the mesh storage location information which are included in the mesh management record of each mesh included in said region with corresponding pieces of information of the mesh management information for update corresponding to the regional map file specified by said input unit.

4. The map information processing device according to claim 2, wherein the update information includes update regional map file range information showing a range of meshes included in a regional map file, and the processor searches through mesh management records for update by limiting its search to a range shown by the update regional map file range information, and rewrites the mesh management records by using mesh management records for update corresponding to the region specified by the input unit.

5. The map information processing device according to claim 4, wherein the update regional map file range information includes information showing an outside shape of an aggregate of meshes included in an update regional map file.

6. The map information processing device according to claim 4, wherein the update regional map file range information includes information showing either rectangles or an aggregate of rectangles outlining an outside shape of an aggregate of meshes included in an update regional map file.

7. The map information processing device according to claim 6, wherein the update regional map file range information includes information showing the range using either a block including a predetermined number of meshes or a block set including this block and a predetermined number of blocks.

8. The map information processing device according to claim 2, wherein when a creation range of the update regional map file is not changed from a previous version, a same filename as a last-time name of the update regional map file is set as a filename of the update regional map file and the processor overwrites the update regional map file in the regional map file stored in the map information storage unit when the regional map file has a same filename as the update regional map file.

9. The map information processing device according to claim 2, wherein when a creation range of an update regional map file is changed from that of a previous version, a filename different from a previous filename of the update regional map file is set as a filename of the update regional map file and the processor stores the update regional map file, as a regional map file, in the map information storage unit when the regional map file has a filename different from that of the update regional map file.

10. The map information processing device according to claim 9, wherein the filename of the regional map file includes information showing a corresponding region, and version information showing a number of times that the creation range has been changed in the region.

11. The map information processing device according to claim 9, wherein the processor identifies a regional map file which is no longer referred to due to an update, and deletes this identified regional map file.

12. The map information processing device according to claim 11, wherein the processor compares the file identifying information stored in each mesh management record with the filename of each regional map file stored in the map information storage unit to identify a regional map file which is no longer referred to due to an update.

13. The map information processing device according to claim 9, wherein when the region specified by the input unit includes a creation range of an already-created regional map file, the processor creates deletion information storing both the filename of the update regional map file, and a list of regional map files from each of which mesh management information will not be referred to due to an update of said update regional map file, and deletes map information stored in the map information storage unit according to the deletion information.

14. The map information processing device according to claim 1, wherein said map information processing device includes a position detecting unit for detecting a current position, and an output unit for displaying map information, and the processor displays both a mesh corresponding to an area to which the current position detected by said position detecting unit belongs, and a mesh having a version older than that of the mesh corresponding to the area to which the current position belongs on said output unit, and, when determining a route leading to a mesh having a version older than that of the mesh corresponding to the area to which the current position belongs or when the map information processing device has entered an area corresponding to a mesh having a version older than that of the mesh corresponding to the area to which the current position belongs, displays information to that effect on said output unit.

15. The map information processing device according to claim 14, wherein the processor acquires version information about a version of each mesh displayed on the output unit from version information about a version of each mesh stored in the mesh management information.
